(19) United States
(12) Patent Application Publication
(10) Pub. No.: US 2022/0159913 A1
(43) Pub. Date: May 26, 2022

(54) DOUBLE-LINED, BOTTOM-WATERING, PLANTER

(71) Applicants: Rikki Cook, Grand Junction, CO (US); Marc Fiot, Grand Junction, CO (US)

(72) Inventors: Rikki Cook, Grand Junction, CO (US); Marc Fiot, Grand Junction, CO (US)

(21) Appl. No.: 17/530,919

(22) Filed: Nov. 19, 2021

Related U.S. Application Data
(60) Provisional application No. 63/205,190, filed on Nov. 23, 2020.

(51) Int. Cl. A01G 9/02; A01G 27/00

(52) U.S. Cl. CPC A01G 9/02; A01G 27/008

(57) ABSTRACT

Details of a planting vessel that includes a bottom-watering system specifically configured to help with care, maintenance, and root growth is described in accordance with examples of the present disclosure. The planting vessel includes a removable insert configured to regulate bottom water flow, aerate soil, and provide flexibility with respect to repotting plants. The planting vessel may include a base, the liner configured to be at least partially disposed within the base, a funnel configured from a portion of the liner and an inner surface portion of the base, the funnel extending from an upper area of the planting vessel to a lower area of the planting vessel, and a watering chamber portion configured from a lower portion of the liner and a portion of the base, the watering chamber portion coupled to the funnel such that a liquid can pass through the funnel to the watering chamber portion.

### PRIORITY APPLICATION

This application claims priority to U.S. Provisional Application Ser. No. 63/205,190, filed Nov. 19, 2020, and titled “Double-Lined, Bottom-Watering, Ceramic Planter” the disclosure of which is incorporated herein by reference in its entirety.

### BACKGROUND

Many indoor gardeners desire the quality and look of a ceramic planter while also looking for the functionality of a flexible planter. Ceramic and composite pots may be aesthetically pleasing but tend to trap rootbound plants inside their rigid walls and often lack proper drainage, if any. While plastic pots and other vessels are convenient, flexible, and often have drainage holes, plastic as a material for use by gardeners often lacks atheistic characteristics found in ceramic and composite material pots.

It is with respect to these and other general considerations that embodiments have been described. Although specific problems have been discussed, the examples described herein should not be limited to solving the specific problems identified in the background above.

### SUMMARY

As disclosed herein, a planting vessel that includes a bottom-watering system specifically configured to help with plant care and maintenance is described in accordance with examples of the present disclosure. More specifically, the planting vessel disclosed herein overcomes the previous problems often present with ceramic and composite pots. That is, the planting vessel described herein includes a removable insert configured to regulate bottom water flow, aerate planting soil, and provide flexibility with respect to allowing for ease of plant care and maintenance.

In accordance with examples of the present disclosure, a planting vessel with removable liner is described. The planting vessel may include a base, a liner configured to be at least partially disposed within the base, a funnel configured from a portion of the liner and an inner surface portion of the base, the funnel extending from an upper area of the planting vessel to a lower area of the planting vessel, and a watering chamber portion configured from a lower portion of the liner and a portion of the base, the watering chamber portion coupled to the funnel such that a liquid can pass through the funnel to the watering chamber portion, and a liquid indication viewing window on the lower wall of the base. In examples, the liner may include a plurality of aeration slots, a plurality of drainage holes, and a plurality of watering holes configured to allow water to pass from the watering chamber portion to a soil area of the liner.

In accordance with examples of the present disclosure, a liner for a planting vessel is described. The liner may include a funnel portion configured to form a hollow funnel when the liner is disposed within a base, a watering chamber portion configured to form a cavity between a lower portion of the liner and a portion of the base when the liner is disposed within the base, a plurality of aeration slots, a plurality of drainage holes, and a plurality of watering holes configured to allow water to pass from the watering chamber portion to a soil area of the liner.

In accordance with examples of the present disclosure, a planting vessel is described. The planting vessel may include a base, a liner configured to be at least partially disposed within the base, wherein a surface of the liner defines an inner soil area such that an amount of soil can be contained therein, and a funnel formed from a surface portion of the liner that is opposite the surface of the liner configuring the inner soil area and an inner surface portion of the base, the funnel extending from an upper area of the planting vessel to a watering chamber portion formed in a lower area of the planting vessel, wherein the watering chamber portion is configured to receive liquid water from the funnel and be viewed through the liquid indication viewing window on the lower wall of the base. In examples, the liner may include a plurality of aeration slots, a plurality of drainage holes, and a plurality of watering holes configured to allow water to pass from the watering chamber portion to the inner soil area.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 depicts details of the planting vessel in accordance with examples of the present disclosure.

FIG. 2 depicts additional details of the planting vessel of FIG. 1 in accordance with examples of the present disclosure.

FIGS. 3-5 depict additional details of the planting vessel of FIG. 1 in accordance with examples of the present disclosure.

FIG. 6 depicts additional details of a liner of the planting vessel in accordance with examples of the present disclosure.

FIG. 7 depicts a bottom view of the liner of FIG. 6 in accordance with examples of the present disclosure.

FIG. 8 depicts perspective view of the liner of FIG. 7 in accordance with examples of the present disclosure.

FIG. 9 depicts perspective view of the liner of FIG. 7 in accordance with examples of the present disclosure.

FIG. 10 depicts a perspective view of a planting vessel in accordance with examples of the present disclosure.

### DETAILED DESCRIPTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices, and materials similar or equivalent to those described can be used in the practice or testing of the invention, the exemplary methods, devices, and materials are now described.

In accordance with examples of the present disclosure, details of a planting vessel that provides a bottom-watering capability configured to address problems associated with plant care and maintenance is described herein. In examples, the planting vessel includes a liner configured to fit at least partially within a vessel portion, such as a pot or container. The liner may be shaped in such a manner as to define or otherwise configure a soil area where a gardener or other person deposits soil for planting. The pot or container may comprise ceramic and/or composite material. Ceramic refers to an inorganic non-metallic solid made up of either metal or nonmetal compounds that have been shaped and then hardened by heating to high temperatures. Common examples of ceramic include but are not limited to earthenware, porcelain, and brick. Ceramic-composites may refer to those ceramic materials that include two or more fundamentally different components that are able to act synergistically to give properties superior to those provided by either component alone. An example of a ceramic composite is concrete, which may include water, sand, gravel, crushed stone, and cement. The liner that is configured to fit at least partially within an outer vessel portion may be made of a material including, but not limited to metal, polymer, carbon fiber, ceramic, and ceramic composite material. Plastic is an example of polymer. Urethane is an example of polymer. In examples, the liner may include or otherwise configure a funnel that transfers water directly to a water chamber portion of the pot or container. The water chamber portion may reside in the bottom portion of the pot or container.

The liner may further include one or more drinking holes configured to allow water from the water chamber portion to enter the soil area. An amount of water entering the soil area may be configured by adjusting a twisting adjuster located at the bottom portion of the liner. The liner may further include a plurality of aeration slots that allow air to circulate through and/or around the soil contained in the soil area. The liner may be configured to include a stabilizing foot design that permits the liner to be removed from the pot or container and placed on the ground. In examples, the stabilizing foot design allows the liner to be placed on the ground without toppling over.

In examples, a gardener, such as an indoor gardener, may select a plant and soil. The gardener or other person may place dirt into the soil area of the liner and plant the selected plant into the soil area containing the dirt. The gardener may then pour water into the funnel thereby adding water to the water chamber portion. As the bottom portion of the soil area and/or liner may contact water in the water chamber portion, water from the water chamber portion—through a wicking action—may move into the soil area of the liner. In examples, the pot or container may include a cut-out window or other indicator that allows a gardener or other person to gauge an amount of water in the water chamber portion of the pot or container. Accordingly, when adding water to the water chamber portion via the straw or funnel, the gardener or other person can add water until the water level, as indicated by the cut-out window or other indicator, reaches a predetermined level, such as but not limited to the top of the cut-out window.

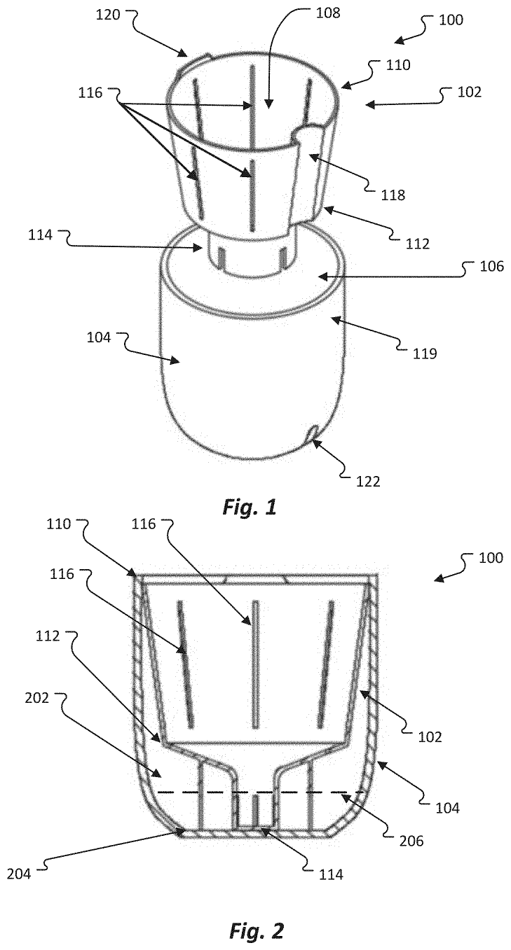

FIG. 1 depicts details of the planting vessel 100 in accordance with examples of the present disclosure. More specifically, the planting vessel 100, may include the liner 102 and the pot or container 104. The liner 102 may be configured to fit within an area or space 106 created by one or more walls of the pot or container 104. As further depicted in FIG. 1, the liner may include a soil area 108; the soil area 108 may be defined by or otherwise create an area or space for containing soil, such as planting soil. In examples, a diameter, radius, or area of a plane formed by a top portion 110 of the soil area 108 may be greater than a diameter, radius, or area of a plane formed by a bottom portion 112 of the soil area 108. Accordingly, a gardener or other person may add soil to the soil area 108, plant a selected plant in the soil of the soil area 108, and then place the liner 102 into the pot or container 104. In examples, the stabilizing foot design 114 may contact a bottom portion of the pot or container 104 when the liner is placed within the pot or container 104.

In accordance with examples of the present disclosure, the liner 102 may include a plurality of aeration slots 116. The plurality of aeration slots 116 may function to aerate soil in the soil area 108. That is, a space may be formed between the liner 102 and the pot or container 104 when the liner 102 is placed within the pot or container 104. The aeration slots 116 provide a mechanism for allowing air to contact the soil in the soil area 108. Although depicted as generally vertical in nature, the aeration slots 116 may be formed in a horizontal fashion such that the aeration slots extend circumferentially about a center of the liner 102 or otherwise are disposed in the liner 102 in a spiral manner. A portion 118 of the liner 102 may form a portion of a straw or funnel for adding water to the water chamber portion of the planting vessel 100. In examples, a straw or funnel may be formed by or otherwise configured by the portion 118 of the liner 102 and a side portion 119 of the pot or container 104. Although a single straw or funnel is depicted in the planting vessel 100 of FIG. 1, more than one straw or funnel may be included in the planting vessel 100. In addition to providing a space for a gardener or other person to add water to the planting vessel 100, the straw or funnel may also provide a means for allowing air to enter the planting vessel 100 when the liner 102 is placed within the pot or container 104. The liner 102 may also include a tab 120 allowing a gardener or other person the ability to easily remove the liner 102 from the pot or container 104. As previously described, the pot or container 104 may include a cut-out window 122 or other indicator that allows a gardener or other person to gauge an amount of water in the water chamber portion of the pot or container. An area may be removed or otherwise not included in the cut-out window 122 and instead may be replaced or otherwise include a material that is transparent or translucent such that a surface of the water touching the inside of the pot or container 104 in the water chamber portion is visible.

FIG. 2 depicts additional details of the planting vessel 100 in accordance with examples of the present disclosure. More specifically, FIG. 2 illustrates a cross-section of the planting vessel 100 when the liner 102 is disposed at least partially within the pot or container 104. When the liner 102 is disposed within the pot or container 104, an upper portion 110 of the liner 102 may contact an internal side surface of the pot or container 104. In examples, the water chamber portion 202 may be defined by or otherwise configured by a portion of the liner 102, for example a bottom portion 112, and an inside bottom portion 204 of the pot or container 104. In examples, water may be added such that a water level 206 contacts or otherwise enters one or more watering holes in the liner 102. The water level 206 may fluctuate up or down based upon an amount of water in the water chamber portion 202. As further depicted in FIG. 2, when the liner 102 is at least partially disposed within the pot or container 104, the stabilizing foot design 114 may contact a bottom portion 204 of the pot or container 104. Further, when the upper portion 110 of the liner 102 contacts an internal side surface of the pot or container 104, the exposure of the water to air in the water chamber portion 202 may be reduced or otherwise limited such that an evaporation rate of water in the water chamber portion is less than an evaporation rate of water in the bottom of the pot or container 104 when the liner 102 is not at least partially disposed in the bottom of the pot or container 104.

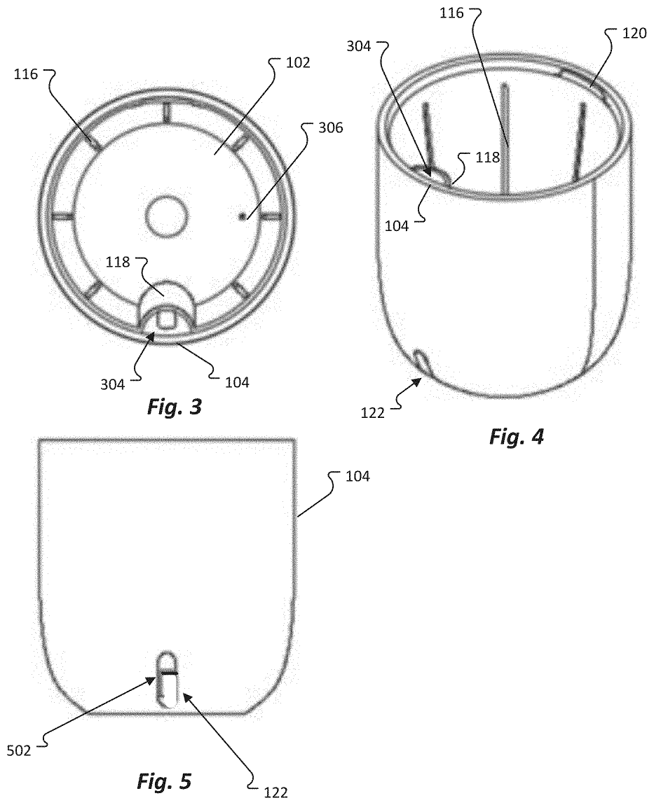

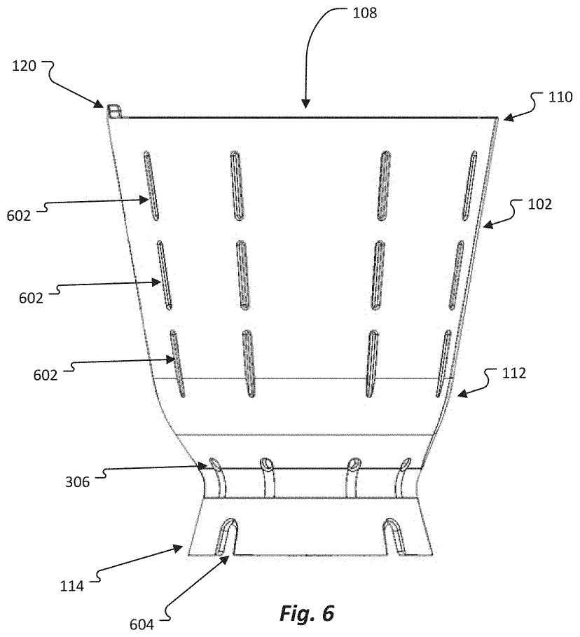

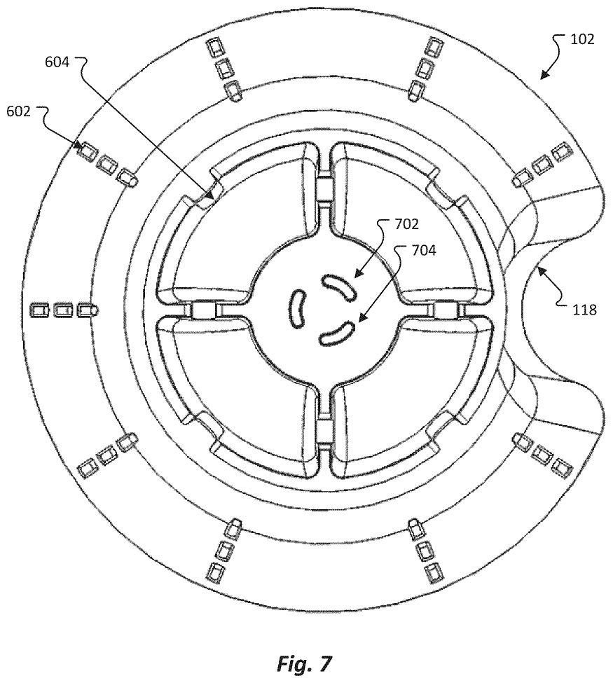

FIGS. 3-5 depict additional details of the planting vessel 100 in accordance with examples of the present disclosure. As depicted in FIG. 3 and FIG. 4, the planting vessel 100 may include a straw or funnel 304. The straw or funnel 304 may be configured by or otherwise be formed by the portion 118 of the liner 102 and an inside surface of the pot or container 104. As depicted in FIG. 3, the portion 118 may be a portion of the liner 102 that deflects inward toward the center of the soil area. The liner 102 may also include one or more drainage holes 306. The one or more drainage holes 306 allow water to drain from the soil in the soil area 108. As depicted in FIG. 4 and FIG. 5 the pot or container 104 may include a cut-out window 122 or other indicator that allows a gardener or other person to gauge an amount of water in the water chamber portion of the pot or container. An area may be removed or otherwise not included in the cut-out window 122 and instead may be replaced or otherwise include a material that is transparent or translucent such that a surface 502 of the water touching the inside of the pot or container 104 in the water chamber portion is visible, where the surface 502 of the water touching the inside of the pot or container 104 in the water chamber portion is indicative of an amount of water in the water chamber portion.

FIG. 6 depicts additional details of the liner 102 in accordance with examples of the present disclosure. As depicted in FIG. 6, the liner 102 may include one or more aeration slots 602; the aeration slots 602 may be different from the aeration slots depicted in FIGS. 1-4 in that a plurality of aeration slots 602 may be disposed in a line. As further depicted in FIG. 6, one or more drainage holes 306 may be included in the liner 102, where the one or more drainage holes 306 allow water to drain from the soil in the soil area 108. FIG. 6 further depicts additional details of the stabilizing foot design 114. The stabilizing foot design 114 may include a plurality of notches 604.

FIG. 7 depicts details of the planting vessel 100 in accordance with examples of the present disclosure. The liner 102 of the planting vessel 100 may include a twisting adjuster 702 located at the bottom portion of the liner 102. In some examples, a twisting adjuster 702 may limit a rate at which water can be wicked into the soil area 108. That is, soil in a lower portion of the soil area 108 (in a lower portion of the liner 102) may contact water in the water chamber portion 202 via one or more slots 704; water may then be wicked through the soil in the lower portion of the soil area 108 and into a larger portion of the soil area 108. By twisting the twisting adjuster 702, an area through which water may pass through the one or more slots 704 may shrink or grow depending on a direction of twist. The larger the area, the faster the water may be wicked into the soil in the soil area 108. The smaller the area, the slower the water may be wicked into the soil in the soil area 108. In examples, a gap or space may exist between a lower most surface of the twisting adjuster 702 and an upper most bottom inner surface (e.g., 204) of the pot or container 104.

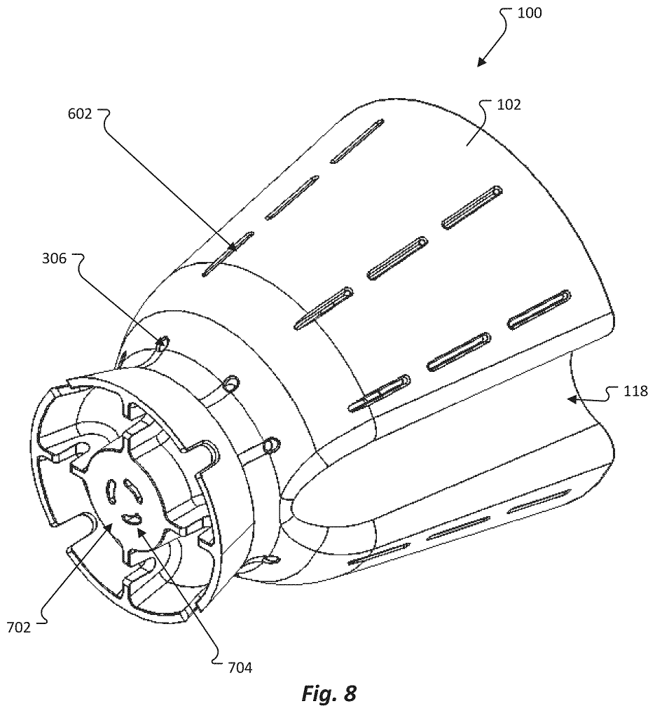

FIG. 8 depicts additional details of the liner 102 of the planting vessel 100 in accordance with examples of the present disclosure. As depicted in FIG. 8, a straw or funnel may be formed by or otherwise configured by at least a portion 118 of the liner 102. The portion 118 of the liner 102 may protrude into the soil area 108 as previously described. The liner 102 may include a plurality of aeration slots 602, a plurality of drainage holes 306, a twisting adjuster 702, and one or more watering holes 704.

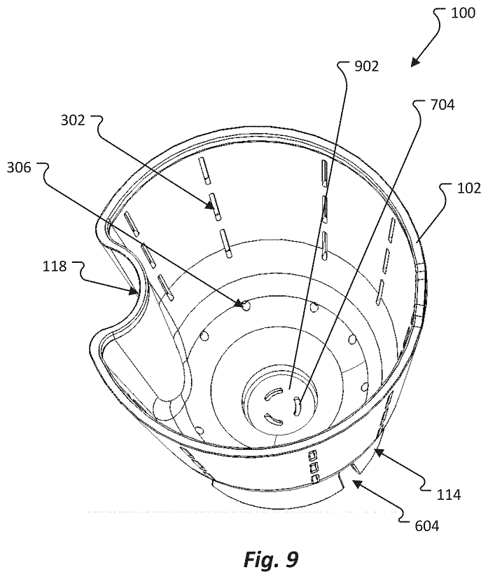

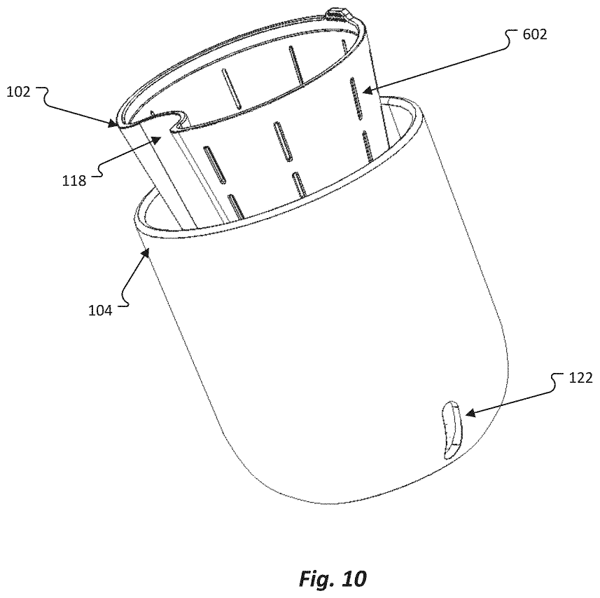

FIG. 9 depicts additional details of the liner 102 of the planting vessel 100 in accordance with examples of the present disclosure. As depicted in FIG. 9, one or more watering holes 704 may be located in a bottom portion of the liner 102. In examples, a surface 902 of the bottom portion of the liner 102 may include the watering holes 704. Thus, water in the watering chamber portion may contact soil in the bottom portion of the liner 102 via the one or more watering holes 704. In examples, where an abundance of water is present in the soil that is in the soil area 108, excess water may flow out of the inside of the liner 102 via the one or more drainage holes 306 such that the drained water may be collected in the water chamber portion. FIG. 10 depicts additional details in a perspective view showing the relation between the liner 102 and the pot or container 104 of the planting vessel 100 in accordance with examples of the present disclosure.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A planting vessel comprising:
a base;
a liner configured to be at least partially disposed within the base;
a funnel configured from a portion of the liner and an inner surface portion of the base, the funnel extending from an upper area of the planting vessel to a lower area of the planting vessel; and
a watering chamber portion configured from a lower portion of the liner and a portion of the base, the watering chamber portion coupled to the funnel such that a liquid can pass through the funnel to the watering chamber portion;
wherein the liner includes:
a plurality of aeration slots,
a plurality of drainage holes, and
a plurality of watering holes configured to allow water to pass from the watering chamber portion to a soil area of the liner.

2. The planting vessel of claim 1, further comprising a liquid level indicator disposed in the base.

3. The planting vessel of claim 2, further comprising an adjusting twister including the watering holes, the adjusting twister configuring an opening area of each watering hole of the plurality of watering holes.

4. The planting vessel of claim 3, further comprising a space between a lower surface of the adjusting twister and a lower inner surface of the base, wherein a plane defined by the lower surface of the adjusting twister and a plane defined by the lower inner surface of the base are substantially parallel.

5. The planting vessel of claim 1, wherein the base is made from a material including ceramic.

6. The planting vessel of claim 4, wherein the liner is made from a material including polymer.

7. The planting vessel of claim 1, wherein the aeration slots are disposed within the liner and at least a portion of one or more aeration slots extend in a vertical direction.

8. The planting vessel of claim 7, wherein two or more aeration slots are disposed in a same plane.

9. The planting vessel of claim 1, further comprising a tab formed in the liner, the tab allowing a user to grasp the liner and remove the liner from the base.

10. A liner for a planting vessel, the liner comprising:
a funnel portion configured to form a hollow funnel when the liner is disposed within a base;
a watering chamber portion configured to form a cavity between a lower portion of the liner and a portion of the base when the liner is disposed within the base;
a plurality of aeration slots;
a plurality of drainage holes; and
a plurality of watering holes configured to allow water to pass from the watering chamber portion to a soil area of the liner.

11. The liner of claim 10, further comprising an adjusting twister including the watering holes, the adjusting twister configuring an opening area of each watering hole of the plurality of watering holes.

12. The liner of claim 10, wherein the liner is made from a material including polymer.

13. The liner of claim 10, wherein the aeration slots are disposed within the liner and at least a portion of one or more aeration slots extend in a vertical direction.

14. The liner of claim 13, wherein two or more aeration slots are disposed in a same plane.

15. The liner of claim 10, further comprising a tab formed in the liner, the tab allowing a user to grasp the liner and remove the liner from the base when the liner is disposed within the base.

16. A planting vessel comprising:
a base;
a liner configured to be at least partially disposed within the base, wherein a surface of the liner defines an inner soil area such that an amount of soil can be contained therein; and
a funnel formed from a surface portion of the liner that is opposite the surface of the liner configuring the inner soil area and an inner surface portion of the base, the funnel extending from an upper area of the planting vessel to a watering chamber portion formed in a lower area of the planting vessel, wherein the watering chamber portion is configured to receive liquid water from the funnel;
wherein the liner includes:
a plurality of aeration slots,
a plurality of drainage holes, and
a plurality of watering holes configured to allow water to pass from the watering chamber portion to the inner soil area.

17. The planting vessel of claim 16, further comprising a liquid level indicator disposed in the base.

18. The planting vessel of claim 17, further comprising an adjusting twister including the watering holes, the adjusting twister configuring an opening area of each watering hole of the plurality of watering holes.

19. The planting vessel of claim 18, further comprising a space between a lower surface of the adjusting twister and a lower inner surface of the base, wherein a plane defined by the lower surface of the adjusting twister and a plane defined by the lower inner surface of the base are substantially parallel.

20. The planting vessel of claim 19, wherein the base is made from a material including ceramic and the liner is made from a material including polymer.
